(19) United States
(12) Patent Application Publication
(10) Pub. No.: US 2025/0060908 A1
(43) Pub. Date: Feb. 20, 2025

(54) MAINTAINING CONNECTION WITH CXL HOST ON RESET

(71) Applicant: Micron Technology, Inc., Boise, ID (US)

(72) Inventors: Melky Arputharaja Siluvainathan, San Jose, CA (US); Rohit Sehgal, San Jose, CA (US); Vishal D. Tanna, Santa Clara, CA (US)

(21) Appl. No.: 18/775,302

(22) Filed: Jul. 17, 2024

Related U.S. Application Data
(60) Provisional application No. 63/533,490, filed on Aug. 18, 2023.

(51) Int. Cl. G06F 3/06; G06F 13/42

(52) U.S. Cl. CPC G06F 3/0659; G06F 3/061; G06F 3/0679; G06F 13/4221; G06F 2213/0026

(57) ABSTRACT

A memory device can be coupled to a host device using a compute express link (CXL) interconnect. The memory device can include a host interface circuit and processing logic circuitry, such as a subsystem manager circuit. The host interface circuit of the memory device can be configured to operate in one of an autonomous mode and a distribution mode. In the autonomous mode, the host interface circuit is configured to maintain a connection between the host device and the memory device while the subsystem manager circuit of the memory device is unavailable, such as when the subsystem manager circuit undergoes a reset routine. In the distribution mode, the host interface circuit is configured to allow communication between the host device and the subsystem manager circuit of the memory device.

### PRIORITY APPLICATION

This application claims the benefit of priority to U.S. Provisional Application Ser. No. 63/533,490, filed Aug. 18, 2023, which is incorporated herein by reference in its entirety.

### BACKGROUND

Memory devices for computers or other electronic devices may be categorized as volatile and non-volatile memory. Volatile memory requires power to maintain its data, and includes random-access memory (RAM), dynamic random-access memory (DRAM), or synchronous dynamic random-access memory (SDRAM), among others. Non-volatile memory can retain stored data when not powered, and includes flash memory, read-only memory (ROM), electrically erasable programmable ROM (EEPROM), static RAM (SRAM), erasable programmable ROM (EPROM), resistance variable memory, phase-change memory, storage class memory, resistive random-access memory (RRAM), and magnetoresistive random-access memory (MRAM), among others. Persistent memory is an architectural property of the system where the data stored in the media is available after system reset or power-cycling. In some examples, non-volatile memory media may be used to build a system with a persistent memory model.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

Various protocols or standards can be applied to facilitate communication between a host and one or more other devices such as memory buffers, accelerators, or other input/output devices. In an example, an unordered protocol such as Compute Express Link (CXL) can be used to provide high-bandwidth and low-latency connectivity.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates generally a block diagram of an example computing system including a host and a memory device.

FIG. 2 illustrates generally an example of a compute express link (CXL) system.

FIG. 3 illustrates generally an example of a C×L system implementing a virtual hierarchy for managing transactions.

FIG. 4 illustrates generally an example of a CXL device with a host interface circuit and a subsystem manager circuit.

FIG. 5 illustrates an example of a first timing diagram for resetting a portion of a CXL device.

FIG. 6 illustrates an example of a second timing diagram for resetting a portion of a CXL device.

FIG. 7 illustrates generally an example of a method for resetting at least a portion of a CXL device.

FIG. 8 illustrates a block diagram of an example machine with which, in which, or by which any one or more of the techniques discussed herein can be implemented.

### DETAILED DESCRIPTION

Compute Express Link (CXL) is an open standard interconnect configured for high-bandwidth, low-latency connectivity between host devices and other devices such as accelerators, memory buffers, and other I/O devices. CXL was designed to facilitate high-performance computational workloads by supporting heterogeneous processing and memory systems. CXL enables coherency and memory semantics on top of PCI Express (PCIe)-based I/O semantics for optimized performance.

In some examples, CXL is used in applications such as artificial intelligence, machine learning, analytics, cloud infrastructure, edge computing devices, communication systems, and elsewhere. Data processing in such applications can use various scalar, vector, matrix and spatial architectures that can be deployed in CPU, GPU, FPGA, smart NICs, or other accelerators that can be coupled using a CXL link.

CXL supports dynamic multiplexing using a set of protocols that includes input/output (CXL.io, based on PCIe), caching (CXL.cache), and memory (CXL.memory or CXL.mem) semantics. In an example, CXL can be used to maintain a unified, coherent memory space between the CPU (e.g., a host device or host processor) and any memory on the attached CXL device. This configuration allows the CPU and the CXL device to share resources and operate on the same memory region for higher performance, reduced data movement, and reduced software stack complexity. In an example, the CPU is primarily responsible for maintaining or managing coherency in a CXL environment. Accordingly, CXL can be leveraged to help reduce device cost and complexity, as well as overhead traditionally associated with coherency across an I/O link.

CXL runs on PCIe PHY and provides full interoperability with PCIe. In an example, a CXL device starts link training in a PCIe Gen 1 Data Rate and negotiates CXL as its operating protocol (e.g., using the alternate protocol negotiation mechanism defined in the PCIe 5.0 specification) if its link partner supports CXL. Devices and platforms can thus more readily adopt CXL by leveraging the PCIe infrastructure and without having to design and validate the PHY, channel, channel extension devices, or other upper layers of PCIe.

In an example, CXL supports single-level switching to enable fan-out to multiple devices. This enables multiple devices in a platform to migrate to CXL, while maintaining backward compatibility and the low-latency characteristics of CXL. In an example, CXL can provide a standardized compute fabric that supports pooling of multiple logical devices (MLD) and single logical devices such as using a CXL switch connected to several host devices or nodes (e.g., Root Ports). This feature enables servers to pool resources such as accelerators and/or memory that can be assigned according to workload. For example, CXL can help facilitate resource allocation or dedication and release. In an example, CXL can help allocate and deallocate memory to various host devices according to need. This flexibility helps designers avoid over-provisioning while ensuring best performance.

Some of the compute-intensive applications and operations mentioned herein can require or use large data sets. Memory devices that store such data sets can be configured for low latency and high bandwidth and persistence. One problem of a load-store interconnect architecture includes guaranteeing persistence. CXL can help address the problem using an architected flow and standard memory management interface for software, such as can enable movement of persistent memory from a controller-based approach to direct memory management.

The present inventors have recognized that a problem to be solved includes facilitating internal device reset for CXL devices, including maintaining a connection between a CXL device and a host during a device reset. A CXL device reset, such as can be used to reset device hardware or load new device firmware, can be triggered in various ways. For example, a device reset can be requested by a host device in a C×L system, or can be initiated internally to the CXL device. For example, a firmware update can require a device reset, or a firmware panic recovery can require a device reset. A CXL device reset can be used to reboot or restart the CXL device such as to load new firmware or to recover the device from a critical failure or fault.

The present inventors have recognized that the problem can include maintaining a connection between the host device and CXL device during a reset operation. For example, a connection can be lost if a device reset brings down all parts or systems of the CXL device. In such an example, transactions in the CXL bus may not be acknowledged or responded to, and accordingly commands from the host can be dropped or expected responses from the CXL device may never arrive. As a result, the connection between the host and CXL device can be lost, and reestablishing a connection can incur a time penalty and may require user intervention.

The present inventors have recognized that during a CXL device reset, it can be desired or expected to maintain a connection between the CXL device and a host device. Accordingly, in an example that includes a reset operation in response to a reset trigger or detected reset condition, the transactions on a CXL bus or interconnect can be undisturbed and events or commands received at the CXL device from the host can be acknowledged and handled. The present inventors have recognized that a solution to these and other problems can include or use a CXL device with a host interface circuit and subsystem manager circuit. The host interface circuit can comprise or control interface logic that manages host commands, host resets, and side-band communications with the host. The subsystem manager circuit can comprise other logic to manage host and side-band transactions, and can comprise or control device-specific logic, such as for one or more circuits or components of the CXL device.

Depending on an operating mode of the CXL device, the host interface circuit or the subsystem manager circuit can be configured to manage transactions with the host device. In other words, the solution to the reset problem can include a multiple-processor system that allows a CXL device reset to occur while maintaining a CXL link between the CXL device and the host. In some examples, the solution allows processing of PCIe and CXL resets, and accommodates side-band events to maintain the CXL device connection with the host, such as while at least a portion of the CXL device undergoes a reset operation.

In an example, the solution includes the CXL device configured to operate in multiple modes, including an autonomous mode and a distribution mode. In the autonomous mode, the subsystem manager circuit may be unavailable due to an ongoing reset, and the CXL device is configured to use the host interface circuit to operate firmware logic to manage PCIe and CXL.io interfaces and side-band interfaces. For example, while the subsystem manager circuit is unavailable, the host interface circuit can apply backpressure on the CXL bus such that the CXL device appears temporarily unavailable, but still connected, to the host. In the distribution mode, or normal operating mode, the subsystem manager circuit is available to handle all transactions with the host.

In an example, the CXL device can be configured to operate in the distribution mode by default, however, the subsystem manager circuit can comprise logic to detect or determine when to use the autonomous mode. In an example, the subsystem manager circuit can be configured to control or instruct the host interface circuit to enter the autonomous mode under particular circumstances. For example, the CXL device can be caused to enter or use the autonomous mode under circumstances such as (1) a cold boot or initial host initialization of the CXL device, (2) receiving a host-initiated reset or reset command, or (3) a CXL device-initiated reset, such as in response to a triggering event such as a critical failure or other device condition.

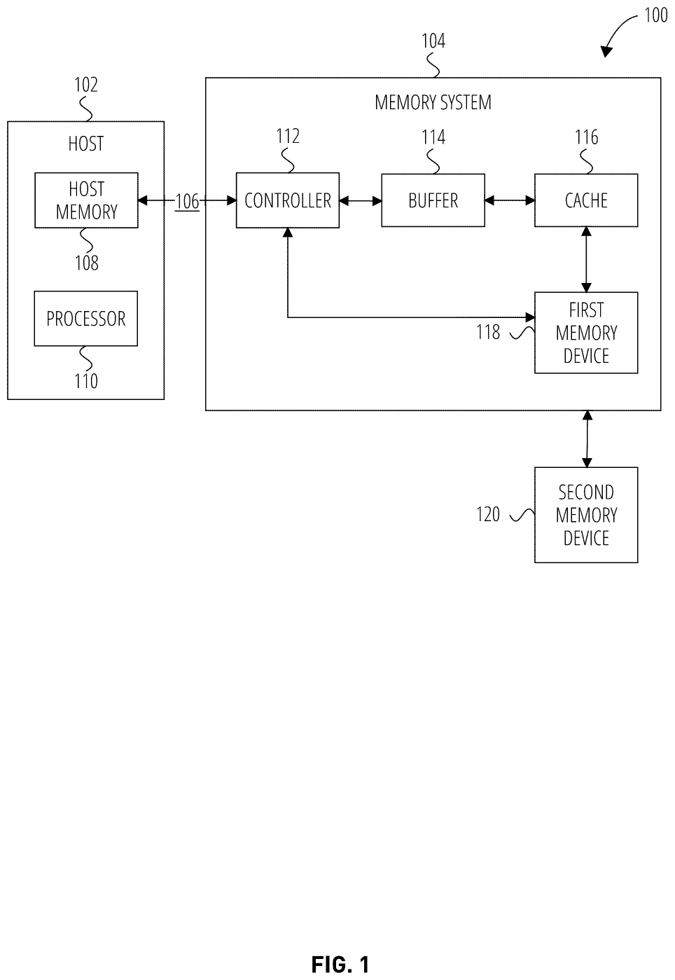

FIG. 1 illustrates generally a block diagram of an example of a computing system 100 including a host device 102 and a memory system 104. The host device 102 includes a central processing unit (CPU) or processor 110 and a host memory 108. In an example, the host device 102 can include a host system such as a personal computer, a desktop computer, a digital camera, a smart phone, a memory card reader, and/or Internet-of-things enabled device, among various other types of hosts, and can include a memory access device, e.g., the processor 110. The processor 110 can include one or more processor cores, a system of parallel processors, or other CPU arrangement.

The memory system 104 includes a controller 112, a buffer 114, a cache 116, and a first memory device 118. The first memory device 118 can include, for example, one or more memory modules (e.g., single in-line memory modules, dual in-line memory modules, etc.). The first memory device 118 can include volatile memory and/or non-volatile memory, and can include a multiple-chip device that comprises one or multiple different memory types or modules. In an example, the computing system 100 includes a second memory device 120 that interfaces with the memory system 104 and the host device 102.

The host device 102 can include a system backplane and can include a number of processing resources (e.g., one or more processors, microprocessors, or some other type of controlling circuitry). The computing system 100 can optionally include separate integrated circuits for the host device 102, the memory system 104, the controller 112, the buffer 114, the cache 116, the first memory device 118, the second memory device 120, any one or more of which may comprise respective chiplets that can be connected and used together. In an example, the computing system 100 includes a server system and/or a high-performance computing (HPC) system and/or a portion thereof. Although the example shown in FIG. 1 illustrates a system having a Von Neumann architecture, embodiments of the present disclosure can be implemented in non-Von Neumann architectures, which may not include one or more components (e.g., CPU, ALU, etc.) often associated with a Von Neumann architecture.

In an example, the first memory device 118 can provide a main memory for the computing system 100, or the first memory device 118 can comprise accessory memory or storage for use by the computing system 100. In an example, the first memory device 118 or the second memory device 120 includes one or more arrays of memory cells, e.g., volatile and/or non-volatile memory cells. The arrays can be flash arrays with a NAND architecture, for example. Embodiments are not limited to a particular type of memory device. For instance, the memory devices can include RAM, ROM, DRAM, SDRAM, PCRAM, RRAM, and flash memory, among others.

In embodiments in which the first memory device 118 includes persistent or non-volatile memory, the first memory device 118 can include a flash memory device such as a NAND or NOR flash memory device. The first memory device 118 can include other non-volatile memory devices such as non-volatile random-access memory devices (e.g., NVRAM, ReRAM, FeRAM, MRAM, PCM), memory devices such as a ferroelectric RAM device that includes ferroelectric capacitors that can exhibit hysteresis characteristics, a 3-D Crosspoint (3D XP) memory device, etc., or combinations thereof.

In an example, the controller 112 comprises a media controller such as a non-volatile memory express (NVMe) controller. The controller 112 can be configured to perform operations such as copy, write, read, error correct, etc. for the first memory device 118. In an example, the controller 112 can include purpose-built circuitry and/or instructions to perform various operations. That is, in some embodiments, the controller 112 can include circuitry and/or can be configured to perform instructions to control movement of data and/or addresses associated with data such as among the buffer 114, the cache 116, and/or the first memory device 118 or the second memory device 120.

In an example, at least one of the processor 110 and the controller 112 comprises a command manager (CM) for the memory system 104. The CM can receive, such as from the host device 102, a read command for a particular logic row address in the first memory device 118 or the second memory device 120. In some examples, the CM can determine that the logical row address is associated with a first row based at least in part on a pointer stored in a register of the controller 112. In an example, the CM can receive, from the host device 102, a write command for a logical row address, and the write command can be associated with second data. In some examples, the CM can be configured to issue, to non-volatile memory and between issuing the read command and the write command, an access command associated with the first memory device 118 or the second memory device 120. In some examples, the CM can issue, to the non-volatile memory and between issuing the read command and the write command, an access command associated with the first memory device 118 or the second memory device 120.

In an example, the buffer 114 comprises a data buffer circuit that includes a region of a physical memory used to temporarily store data, for example, while the data is moved from one place to another. The buffer 114 can include a first-in, first-out (FIFO) buffer in which the oldest (e.g., the first-in) data is processed first. In some embodiments, the buffer 114 includes a hardware shift register, a circular buffer, or a list.

In an example, the cache 116 comprises a region of a physical memory used to temporarily store particular data that is likely to be used again. The cache 116 can include a pool of data entries. In some examples, the cache 116 can be configured to operate according to a write-back policy in which data is written to the cache without being concurrently written to the first memory device 118. Accordingly, in some embodiments, data written to the cache 116 may not have a corresponding data entry in the first memory device 118.

In an example, the controller 112 can receive write requests (e.g., from the host device 102) involving the cache 116 and cause data associated with each of the write requests to be written to the cache 116. In some examples, the controller 112 can receive the write requests at a rate of thirty-two (32) gigatransfers (GT) per second, such as according to or using a CXL protocol. The controller 112 can similarly receive read requests and cause data stored in, e.g., the first memory device 118 or the second memory device 120, to be retrieved and written to, for example, the host device 102 via an interface 106.

In an example, the interface 106 can include any type of communication path, bus, or the like that allows information to be transferred between the host device 102 and the memory system 104. Non-limiting examples of interfaces can include a peripheral component interconnect (PCI) interface, a peripheral component interconnect express (PCIe) interface, a serial advanced technology attachment (SATA) interface, and/or a miniature serial advanced technology attachment (mSATA) interface, among others. In an example, the interface 106 includes a PCIe 5.0 interface that is compliant with the compute express link (CXL) protocol standard. Accordingly, in some embodiments, the interface 106 supports transfer speeds of at least 32 GT/s.

As similarly described elsewhere herein, CXL is a high-speed central processing unit (CPU)-to-device or CPU-to-memory interconnect designed to enhance compute performance. CXL technology maintains memory coherency between a CPU memory space (e.g., the host memory 108) and memory on attached devices or accelerators (e.g., the first memory device 118 or the second memory device 120), which allows resource sharing for higher performance, reduced software stack complexity, and lower overall system cost. CXL is designed to be an industry open standard interface for high-speed communications as accelerators are increasingly used to complement CPUs in support of emerging data-rich and compute-intensive applications such as artificial intelligence and machine learning.

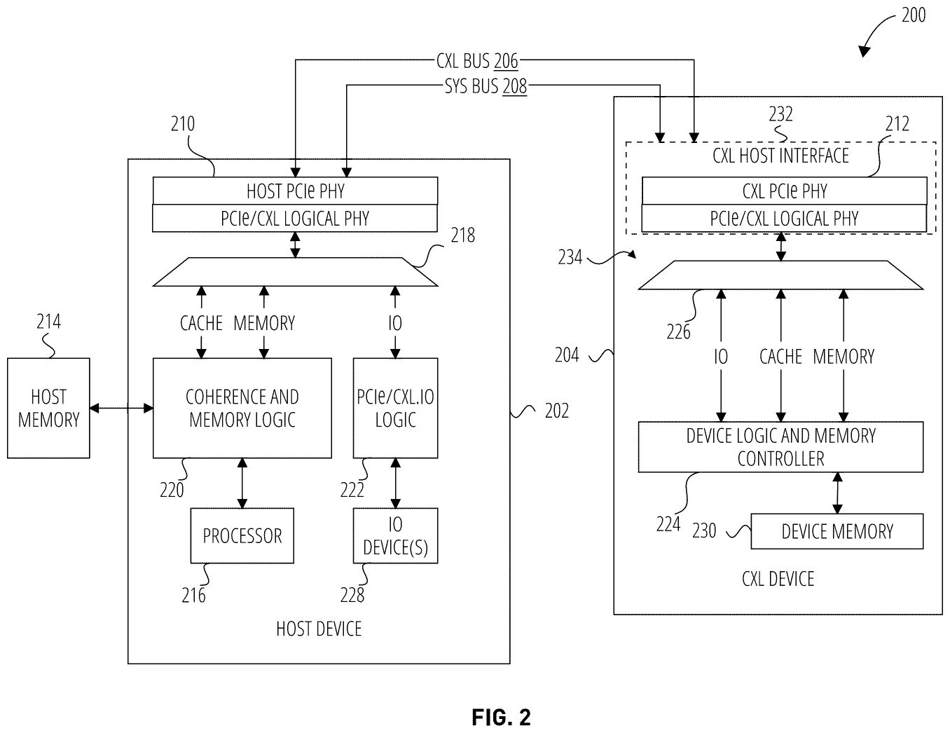

FIG. 2 illustrates generally an example of a C×L system 200 that uses a bus system, including a CXL link bus 206 and a system management bus 208, to connect a host device 202 and a CXL device 204. In an example, the host device 202 comprises or corresponds to the host device 102 and the CXL device 204 comprises or corresponds to the memory system 104 from the example of the computing system 100 in FIG. 1. A memory system command manager (CM) can comprise a portion of the host device 202 or the CXL device 204.

In an example, the system management bus 208 (e.g., corresponding to a portion of the interface 106 from the example of FIG. 1) is configured to support main-band or side-band communications between the host device 202 and the CXL device 204. The system management bus 208 can carry miscellaneous commands or events using PCIe and CXL protocols, such as link speed changes, reset commands issued by the host, and other reliability, availability, and serviceability features.

In an example, the CXL link bus 206 (e.g., corresponding to a portion of the interface 106 from the example of FIG. 1) can support communications using multiplexed protocols for caching (e.g., CXL.cache), memory accesses (e.g., CXL.mem or CXL.memory), and data input/output transactions (e.g., CXL.io). CXL.io can include a protocol based on PCIe that is used for functions such as device discovery, configuration, initialization, I/O virtualization, and direct memory access (DMA) using non-coherent load-store, producer-consumer semantics. CXL.cache can enable a device to cache data from the host memory (e.g., from the host memory 214) using a request and response protocol. CXL.memory can enable the host device 202 to use memory attached to the CXL device 204, for example, in or using a virtualized memory space. The CXL-based memory device can include or use a volatile or non-volatile memory such that it can be characterized by different speeds or latencies. In an example, the CXL-based memory device can include a CXL-based memory controller configured to manage transactions with the volatile or non-volatile memory.

In an example, CXL.memory transactions can be memory load and store operations that run downstream from or outside of the host device 202. CXL memory devices can have different levels of complexity. For example, a simple CXL memory system can include a CXL device that includes, or is coupled to, a single media controller, such as a memory controller (MEMC). A moderate CXL memory system can include a CXL device that includes, or is coupled to, multiple media controllers. A complex CXL memory system can include a CXL device that includes, or is coupled to, a cache controller (and its attendant cache) and to one or more media or memory controllers.

In the example of FIG. 2, the host device 202 includes a host processor 216 (e.g., comprising one or more CPUs or cores) and IO device(s) 228. The host device 202 can comprise, or can be coupled to, host memory 214. The host device 202 can include various circuitry or logic configured to facilitate CXL-based communications and transactions with the CXL device 204. For example, the host device 202 can include coherence and memory logic 220 configured to implement transactions according to CXL.cache and CXL.memory semantics, and the host device 202 can include PCIe logic 222 configured to implement transactions according to CXL.io semantics. In an example, the host device 202 can be configured to manage coherency of data cached at the CXL device 204 using, e.g., its coherence and memory logic 220.

The host device 202 can further include a host multiplexer 218 configured to modulate communications over the CXL link bus 206 (e.g., using the PCIe PHY layer). The multiplexing of protocols ensures that latency-sensitive protocols (e.g., CXL.cache and CXL.memory) have the same or similar latency as a native processor-to-processor link. In an example, CXL defines an upper bound on response times for latency-sensitive protocols to help ensure that device performance is not adversely impacted by variation in latency between different devices implementing coherency and memory semantics.

In an example, symmetric cache coherency protocols can be difficult to implement between host processors because different architectures may use different solutions, which in turn can compromise backward compatibility. CXL can address this problem by consolidating the coherency function at the host device 202, such as using the coherence and memory logic 220.

The CXL device 204 can include various components or logical blocks including a CXL host interface 232 and a device management system 234. In an example, the CXL host interface 232 can be configured to receive and manage various requests and transactions. For example, the CXL host interface 232 can be configured to receive and communicate PCIe resets such as using PERST (PCI Express Reset), Hot Reset, FLR (function level reset), and CXL resets. In an example, the CXL host interface 232 can be configured to receive and communicate DOE Transaction layer packets. In an example, the CXL host interface 232 can be configured to handle side-band requests or other miscellaneous events from PCIe and CXL devices, such as using the CXL link bus 206 or the system management bus 208.

The CXL host interface 232 can include or use multiple CXL interface physical layers 212. The device management system 234 can include, among other things, the device logic and memory controller 224. In an example, the CXL device 204 can comprise a device memory 230, or can be coupled to another memory device. The CXL device 204 can include various circuitry or logic configured to facilitate CXL-based communications and transactions with the host device 202 using the CXL link bus 206. For example, the device logic and memory controller 224 can be configured to implement transactions received using the CXL host interface 232 according to CXL.cache, CXL.memory, and CXL.io semantics. The CXL device 204 can include a CXL device multiplexer 226 configured to control communications over the CXL link bus 206.

In an example, one or more of the coherence and memory logic 220, the device management system 234, and the device logic and memory controller 224 comprises a Unified Assist Engine (UAE) or compute fabric with various functional units such as a command manager (CM), Threading Engine (TE), Streaming Engine (SE), Data Manager or data mover (DM), or other unit. The compute fabric can be reconfigurable and can include separate synchronous and asynchronous flows.

The device management system 234 or the device logic and memory controller 224 or portions thereof can be configured to operate in an application space of the C×L system 200 and, in some examples, can initiate its own threads or sub-threads, which can operate in parallel and can optionally use resources or units on other CXL devices 204. Queue and transaction control through the system can be coordinated by the CM, TE, SE, or DM components of the UAE. In an example, each queue or thread can map to a different loop iteration to thereby support multi-dimensional loops. With the capability to initiate such nested loops, among other capabilities, the system can realize significant time savings and latency improvements for compute-intensive operations.

In an example, command fencing can be used to help maintain order throughout such operations, which can be performed locally or throughout a compute space of the device logic and memory controller 224. In some examples, the CM can be used to route commands to a particular command execution unit (e.g., comprising the device logic and memory controller 224 of a particular instance of the CXL device 204) using an unordered interconnect that provides respective transaction identifiers (TID) to command and response message pairs.

In an example, the CM can coordinate a synchronous flow, such as using an asynchronous fabric of the reconfigurable compute fabric to communicate with other synchronous flows and/or other components of the reconfigurable compute fabric using asynchronous messages. For example, the CM can receive an asynchronous message from a dispatch interface and/or from another flow controller instructing a new thread at or using a synchronous flow. The dispatch interface may interface between the reconfigurable compute fabric and other system components. In some examples, a synchronous flow may send an asynchronous message to the dispatch interface to indicate completion of a thread.

Asynchronous messages can be used by synchronous flows such as to access memory. For example, the reconfigurable compute fabric can include one or more memory interfaces. Memory interfaces are hardware components that can be used by a synchronous flow or components thereof to access an external memory that is not part of the synchronous flow but is accessible to the host device 202 or the CXL device 204. A thread executed using a synchronous flow can include sending a read and/or write request to a memory interface. Because reads and writes are asynchronous, the thread that initiates a read or write request to the memory interface may not receive the results of the request. Instead, the results of a read or write request can be provided to a different thread executed at a different synchronous flow. Delay and output registers in one or more of the CXL devices 204 can help coordinate and maximize efficiency of a first flow, for example, by precisely timing engagement of particular compute resources of one device with arrival of data relevant to the first flow. The registers can help enable the particular compute resources of the same resource to be repurposed for flows other than the first flow, for example while the first flow dwells or waits for other data or operations to complete. Such other data or operations can depend on one or more other resources of the fabric.

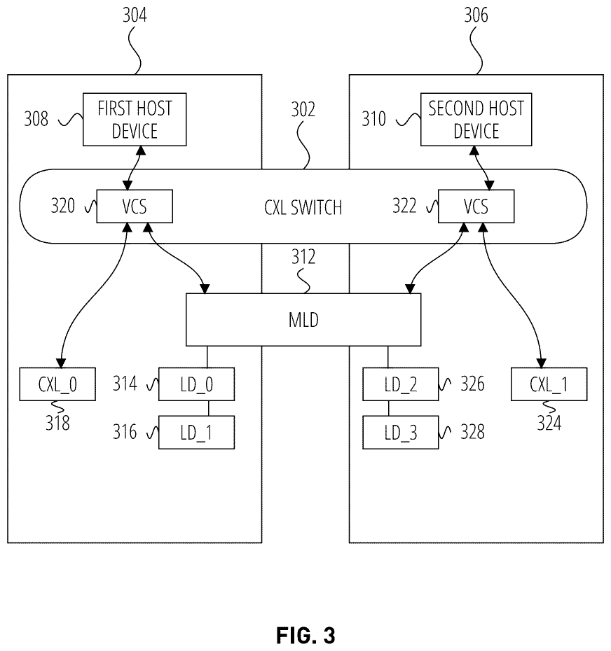

FIG. 3 illustrates generally an example of a portion of a C×L system that can include or use a virtual hierarchy for managing transactions, such as memory transactions with a CXL memory device. The example can include or use real-time telemetry to help facilitate allocation of new or ongoing queues. The example of FIG. 3 includes a first virtual hierarchy 304 and a second virtual hierarchy 306. The first virtual hierarchy 304, the second virtual hierarchy 306, or one or more modules or components thereof can be implemented using the host device 202, the CXL device 204, or multiple instances of the host device 202 or the CXL device 204.

In the example of FIG. 3, the first virtual hierarchy 304 includes a first host device 308 and the second virtual hierarchy 306 includes a second host device 310. A CXL switch 302 can be provided to expose multiple CXL resources to different hosts in the system. In other words, the CXL switch 302 can be configured to couple each of the first host device 308 and the second host device 310 to the same or different resources, such as using respective virtual CXL switches (VCS), such as a first VCS 320 and a second VCS 322, respectively. The CXL switch 302 can be statically configured to couple each host device to respective different resources or the CXL switch 302 can be dynamically configured to the different resources, such as depending on the needs of a particular one of the host devices to execute its respective queues or threads. Accordingly, the CXL switch 302 enables virtual hierarchies and resource sharing among different hosts.

In an example, a fabric manager (FM) can be provided to assign or coordinate connectivity of the CXL switch 302 and can be configured to initiate, dissolve, or reconfigure the virtual hierarchies of the C×L system. The FM can include a baseboard management controller (BMC), an external controller, a centralized controller, or other controller.

In the example of FIG. 3, the CXL switch 302, or the first VCS 320 or the second VCS 322, can coordinate communication between the host devices and various accelerators. For example, the CXL switch 302 can be coupled to various CXL devices (e.g., a first CXL device 318 or a second CXL device 324), or to various logical devices, such as a single logical device (LD, e.g., a first LD 314, a second LD 316, a third LD 326, or a fourth LD 328) via a multiple logic device (MLD, e.g., an MLD 312). Each CXL device and logical device can represent a respective accelerator or CXL device with its own respective CXL.io configuration space, CXL.mem memory space, and CXL.cache cache space.

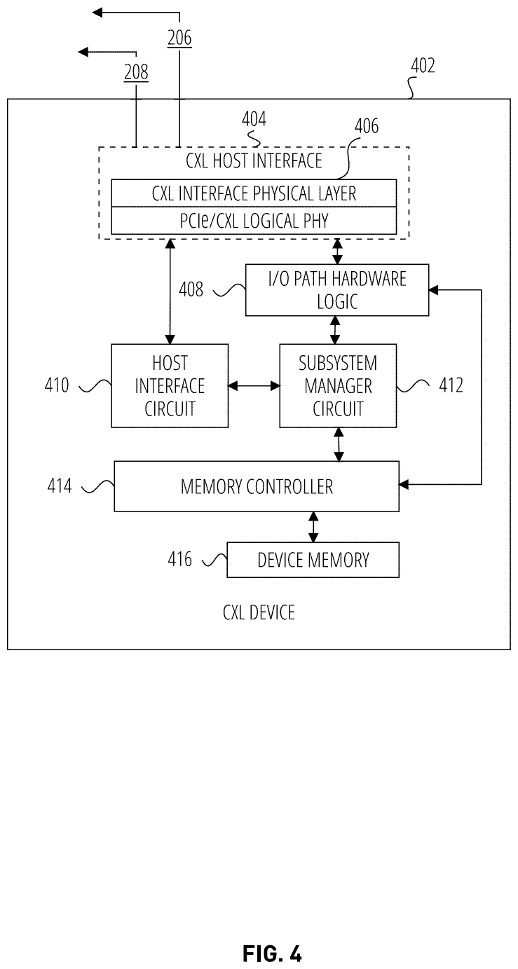

FIG. 4 illustrates generally an example of an example CXL device 402 configured to use the CXL link bus 206 and the system management bus 208 to connect to a host device, such as the host device 202, or to connect to one or more other CXL devices. The example CXL device 402 can comprise an example of the CXL device 204, the first CXL device 318, the second CXL device 324, or another device.

For ease of illustration and discussion, the example CXL device 402 can include a notional front end portion, a middle end portion, and a back end portion. The portions and components thereof can be differently configured or combined according to different implementations of the example CXL device 402. In the example of FIG. 4, the front end portion can include the CXL link bus 206, the system management bus 208, a CXL host interface 404, CXL interface physical layers 406, and I/O Path hardware logic 408. In examples, the front end portion includes a CXL data link layer and a CXL transport layer configured to manage various transactions with the host. In an example, the CXL transport layer comprises registers and operators configured to manage CXL request queues (e.g., comprising one or more memory transaction requests) and CXL response queues (e.g., comprising one or more memory transaction responses) for the example CXL device 402.

The example CXL device 402 can include or use the CXL host interface 404, such as comprising one or more CXL interface physical layers 406 and I/O Path hardware logic 408, coupled to the CXL link bus 206 or the system management bus 208, and using multiplexed protocols for caching (e.g., CXL.cache), memory accesses (e.g., CXL.mem or CXL.memory), and data input/output transactions (e.g., CXL.io). The CXL host interface 404 can comprise an example of the CXL host interface 232 described above in the example of FIG. 2.

Depending on an operating mode of the example CXL device 402, data transactions can be passed from the I/O Path hardware logic 408 to one or both of a host interface circuit 410 and a subsystem manager circuit 412. In an example, the CXL host interface 404 and the I/O Path hardware logic 408 comprise always-on logic of the example CXL device 402 that is not reset during an internal reset operation that involves one or both of the host interface circuit 410 and the subsystem manager circuit 412. In an example, the I/O Path hardware logic 408 can be configured to interface directly with the memory controller 414.

The example CXL device 402 can be a memory device that includes a cache (e.g., comprising SRAM) and can include longer-term volatile or non-volatile memory accessible via a memory controller. For example, the example CXL device 402 can include a cache memory in the middle end portion of the device. The middle end portion can further include a cache controller configured to monitor requests from the CXL transport layer and identify requests that can be fulfilled using the cache memory.

Various complexities can arise in C×L systems. For example, CXL transactions can be based on a relatively large transaction size (e.g., 64 bytes), while some processes may use more granularity or smaller data sizes. Accordingly, in some examples, the cache controller can be included or used in the device to store excess data fetched from backend media controllers or memories, such as from one or more memories in the back end portion of the example CXL device 402.

In an example, the cache controller is coupled to a cross-bar interface or XBAR interface. The XBAR interface can be configured to allow multiple requesters to access multiple memory controllers in parallel, such as including multiple memory controllers in the back end portion of the device. In an example, the XBAR interface provides essentially point-to-point access between the requestor and memory controller and provides generally higher performance than would be available using a conventional bus architecture. The XBAR interface can be configured to receive responses from the back end portion or receive cache hits from the cache memory and deliver the responses to the front end portion using a cache response queue.

In an example, the back end portion of the example CXL device 402 includes one or more memory controllers, including a first memory controller 414. Each of the memory controllers can have or use respective memory request and response queues. Each of the memory controllers can be coupled to respective media or memories, such as can comprise volatile or non-volatile memory. In an example, each of the multiple memory controllers in the system can manage its own respective queues.

In an example, the middle end portion of the example CXL device 402 can comprise the host interface circuit 410 and the subsystem manager circuit 412. The host interface circuit 410 can be configured to manage some or all communications or transactions with the host device, can be configured to manage host-initiated device resets, and can be configured to manage side-band communications such as using the system management bus 208. In an example, the subsystem manager circuit 412 is configured to manage CXL device-specific behavior or operations. For example, the example CXL device 402 can be a Type 1, Type 2, or Type 3 CXL device, among others. In an example, the example CXL device 402 can include a memory device and the subsystem manager circuit 412 can comprise the memory controller 414 or can comprise circuitry for interfacing with the memory controller 414.

The example CXL device 402 can further include or use one or more device-specific controllers or logic. For example, the example CXL device 402 can comprise a CXL-based memory device with the memory controller 414. The memory controller 414 can be configured to control a device memory 416, such as a volatile or non-volatile memory. In a particular example, the device memory 416 comprises a DRAM or SRAM storage device, or includes a combination of DRAM and SRAM storage devices, and transactions with such devices are managed by the memory controller 414 under the control or direction of the subsystem manager circuit 412.

In an example, the host interface circuit 410 and the subsystem manager circuit 412 can be configured to work together to help manage reset operations for the example CXL device 402. A reset can be requested by the host device or can be initiated internally to the example CXL device 402, such as to perform a firmware update or to recover from a critical failure (e.g., by rebooting). Reset operations can include, for example, pulling down device ports, powering down CPUs or other logic on the device, or otherwise resetting or rebooting one or all portions of the example CXL device 402, which in turn can cause a loss of information on in-band channels (i.e., a portion of the CXL link bus 206 that carries CXL transactions) or side-band channels (e.g., using I2C or I3C protocols) of the system management bus 208. In examples that include device-initiated reset, the host device may not be informed about the reset, or the example CXL device 402 may not have sufficient time or capacity to issue a reset notification to the host. Without prior knowledge about the reset at the example CXL device 402, the host device can expect that transactions or other communications on the CXL link bus 206 or the system management bus 208 are not disturbed. In an example, the example CXL device 402 can use either of the host interface circuit 410 and the subsystem manager circuit 412 to help maintain communication with the host device during a reset of the example CXL device 402 or portions thereof. That is, at least a portion of the example CXL device 402 can be configured to operate and keep up communication with the host device so that the connection between the host device and the example CXL device 402 is not lost when all or a portion of the example CXL device 402 undergoes reset.

In an example, a firmware update for the example CXL device 402 can be used to add or change device features or operations. The CXL specification provides mailbox commands to update firmware. Side-band protocols can also have defined mechanisms for updating firmware. To update firmware, the firmware instructions or update can be loaded at the example CXL device 402 and then an internal reset (i.e., internal to the example CXL device 402) is performed so that device CPUs can start to run the new or updated firmware.

In an example, a failure recovery, or panic recovery, can include a reset that is initiated in response to an error condition detected at, and optionally detected by, the example CXL device 402. In an example, the failure recovery reset can include collecting a memory snapshot for debugging and, after data is collected, performing the reset or reboot to determine if the device can be recovered. The failure recovery reset can be a device-level reset and is not in response to, or based on, a command from the host device.

The present inventors have recognized that performing a reset at the example CXL device 402 can include or use multiple logic circuits or processors in coordination to help ensure that communication with the host device is maintained, and that host commands are acknowledged throughout the reset operation. The solution can include or use the host interface circuit 410 and the subsystem manager circuit 412 such that a portion of the example CXL device 402 has at least one logical block that is always on and available to handle communications on the CXL link bus 206 or the system management bus 208.

Referring again to the example of the CXL device 204 from the example of FIG. 2, the CXL device 204 includes a centralized device management system 234. Accordingly, to reset the CXL device 204, the device management system 234 is brought down and reset, and a connection with the host device can be lost. In contrast, the example CXL device 402 from FIG. 4 includes the host interface circuit 410 and the subsystem manager circuit 412 each configured to manage a host connection throughout a reset.

For example, the host interface circuit 410 can be configured to maintain a connection to a host device while quiescing the IO path of the CXL link bus 206. For example, the host interface circuit 410 can suppress communication by applying backpressure on the CXL link bus 206 such as by issuing fewer or zero credits to the host device to slow or stop traffic on the CXL link bus 206 or the system management bus 208 between the host device and the example CXL device 402. Suppressing communication, in various examples, can include reducing an amount or volume of communication without completely stopping or eliminating communication using particular channels or a particular bus or link. In other examples, suppressing communication can include stopping or eliminating communication along the channels, bus, or link. In an example, suppressing communication to reset the IO path includes pausing or stopping memory device commands or packets while allowing other packets to flow to maintain the CXL connection between the host device and the CXL device 402. While the host interface circuit 410 maintains the connection with the host device, all or a portion of the subsystem manager circuit 412, or the circuits under its control such as the memory controller 414 or the device memory 416, among others, can be reset. The reset can be customizable or configurable, and can involve reset of one or more functional blocks of the subsystem manager circuit 412. When the subsystem manager circuit 412 reset is completed, then the host interface circuit 410 can relax the backpressure and begin issuing additional credits to the host to resume normal traffic and command handling.

In another example, the subsystem manager circuit 412 can be configured to maintain a connection to the host device while the host interface circuit 410 or a portion thereof undergoes reset. That is, the subsystem manager circuit 412 can be configured to apply backpressure on the CXL link bus 206 by managing the credits issued from the example CXL device 402 to the host device. When reset of the host interface circuit 410 is completed, then normal operation can resume using the host interface circuit 410 and the subsystem manager circuit 412 together.

### CXL Device Operating Modes

In an example, the subsystem manager circuit 412 can be configured to operate in multiple modes including an “autonomous mode” and a “distribution mode.” Normal or default operations can use the distribution mode. In distribution mode, no device-internal reset occurs, and all the hardware and firmware of the CXL device can be considered operational. When there is a need to reset, the subsystem manager circuit 412 can direct the host interface circuit 410 to use the autonomous mode. In autonomous mode, a device-internal reset can occur. In autonomous mode, the host interface circuit 410 can be operational while the subsystem manager circuit 412, or portions thereof, undergo reset and are therefore unavailable for managing transactions on the CXL link bus 206 or the system management bus 208. That is, the host interface circuit 410 can be configured to handle side-band and main-band transactions on the system management bus 208 and the CXL link bus 206, respectively, such as using the CXL host interface 404. In an example, the subsystem manager circuit 412 can be configured to determine when or whether to change operating modes between distribution mode and autonomous mode.

The CXL host interface 404 can be configured to manage requests such as for PCIe resets, CXL resets, DOE transaction layer packets, and side-band commands (e.g., regarding link speed changes), as similarly described above for the CXL host interface 232 of the CXL device 204. Such requests can be handled by the example CXL device 402 in autonomous mode and in distribution mode. In autonomous mode, however, the subsystem manager circuit 412 can be quiesced or unavailable, and accordingly the CXL host interface 404 can operate together with, or at the direction of, the host interface circuit 410, to handle such requests.

In an example, when the host interface circuit 410 is directed to use the autonomous mode (e.g., directed by the subsystem manager circuit 412), the host interface circuit 410 can assume the CXL.mem path is clean because the subsystem manager circuit 412 already applied, or began to apply, backpressure to the bus to reduce the number of new requests or transactions arriving at the example CXL device 402. In an example, a transition to the autonomous mode can include checking whether a device-attached memory is initialized and, after a specified delay, device cache can be offloaded (e.g., to the device memory 416 or elsewhere) to ensure any cache managed by the example CXL device 402 is clean, such as prior to a reset.

In an example, the subsystem manager circuit 412 can comprise logic to detect when to use the autonomous mode. For example, the logic can initiate autonomous mode operation when the example CXL device 402 completes a cold boot sequence and before the host enables the device memory. In this case, because the device memory is not yet enabled, there is no traffic and therefore there is no need to manage the entire memory subsystem. Accordingly, the host interface circuit 410 can operate alone, and one or more portions of the subsystem manager circuit 412 can be powered down or quiesced.

In a second example, the hardware or software-implemented logic of the subsystem manager circuit 412 can initiate autonomous mode operation when a host-initiated PCIe or CXL reset completes. In this example, the host is aware of the reset operation and the device can wait for the host to enable the memory or other portion of the example CXL device 402. Accordingly, the host interface circuit 410 can operate alone, and one or more portions of the subsystem manager circuit 412 can remain powered down or quiesced.

In a third example, the logic of the subsystem manager circuit 412 can initiate autonomous mode operation when a CXL device initiates an internal reset. In this case, the device firmware can quiesce the device ports and clean up pending commands (e.g., by waiting or aborting), and can initialize the device memory. In the case of reset due to device failure or panic, cleanup can be expedited and performed without delay to ensure completion of a maximum number of pending commands. In the case of reset due to firmware update, cleanup can be performed while backpressure is applied to the CXL link bus 206. Following cleanup, such as including moving cached data to the device memory 416, the host interface circuit 410 can operate alone while the subsystem manager circuit 412 resets.

The subsystem manager circuit 412 can thus be configured to detect various conditions or situations that indicate a need for operating the example CXL device 402 in autonomous mode, such as can include instructing the host interface circuit 410 to temporarily take over management of transactions with the host device while the subsystem manager circuit 412 resets or is otherwise unavailable. Generally, in other cases, the example CXL device 402 can operate in the distribution mode with the host interface circuit 410 managing main-band and/or side-band transactions with the host and the subsystem manager circuit 412 controlling device-internal processes responsive to host commands.

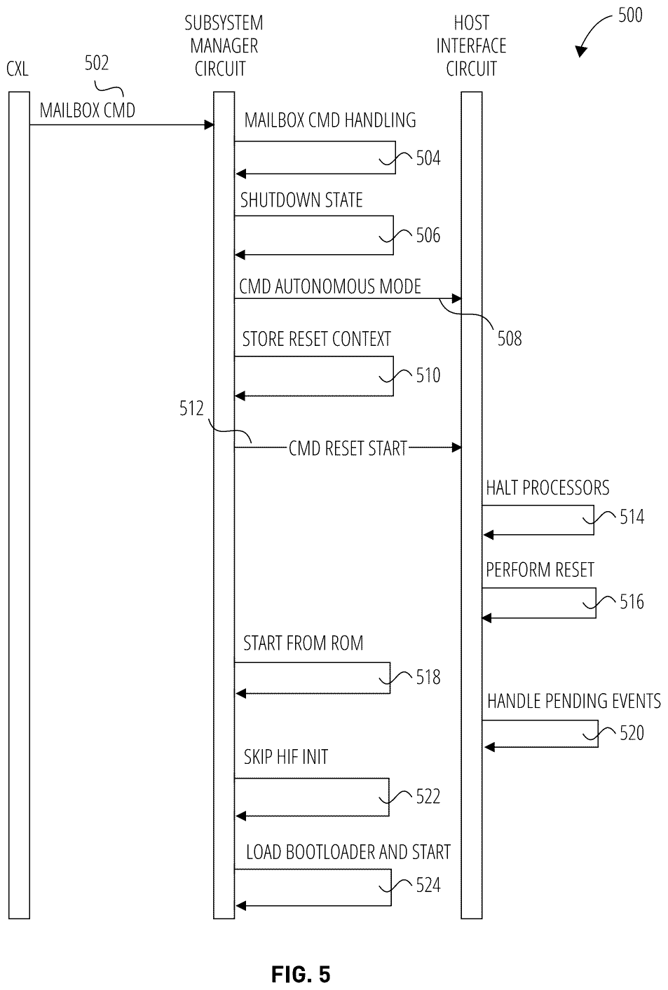

FIG. 5 illustrates generally an example of a first timing diagram 500 for interface management during an internal reset, such as for the example CXL device 402. In an example, the first timing diagram 500 illustrates generally a process that can include transitioning portions of the example CXL device 402 from distribution mode to autonomous mode, and updating firmware of the subsystem manager circuit 412.

The first timing diagram 500 can begin at operation 502 with receiving a mailbox command for device reset via the CXL link bus 206. For example, the command can be sent by the host device. In an example, operation 502 includes receiving a mailbox command that causes an internal reset to accomplish the command handling. In an example, the subsystem manager circuit 412 receives the mailbox command and initiates an acknowledgement or other device response at operation 504.

At operation 506, the subsystem manager circuit 412 can command subsystems of the example CXL device 402 to quiesce or halt activity. For example, operation 506 can include managing pending main-band or side-band commands, closing down interfaces or other ports, and drawing down a command count to zero. Operation 506 can include emptying queues, hardware FIFOs, caches, or other components that will be cleared upon reset. In an example, operation 506 includes applying backpressure to commands on the CXL link bus 206 or system management bus 208, or issuing fewer or zero credits to a host device, to ensure fewer or zero commands arrive at the example CXL device 402 during reset.

At operation 508, the subsystem manager circuit 412 can inform the host interface circuit 410 that the subsystem manager circuit 412 will begin operating in the autonomous mode and that the host interface circuit 410 can undergo reset. In an example, at operation 510, the subsystem manager circuit 412 can store reset context information, such as a device state, register status, or other information about the device at the time when, or before, the command was received at operation 502. Following the context loading at operation 510, operation 512 can include using the subsystem manager circuit 412 to instruct the host interface circuit 410 to perform a reset. In response, the host interface circuit 410 can halt processes at operation 514 and, after a specified delay or after a command count or queue reaches zero, operation 516 can include resetting the host interface circuit 410.

When the host interface circuit 410 reset completes, the host interface circuit 410 can be initialized to manage communications with the host device. Accordingly, the subsystem manager circuit 412 can begin its reset at operation 518. For example, operation 518 can include or use ROM code (e.g., newly loaded or updated code) to initialize the subsystem manager circuit 412. While the subsystem manager circuit 412 loads, the host interface circuit 410 can handle any pending events at operation 520 and maintain a connection with the host device. Because the host interface circuit 410 is already operational and managing the host connection, at operation 522, initialization of the host interface circuit 410 (such as including a power cycle) can be skipped. At operation 524, a bootloader can be used to load relevant code or applications to registers of the subsystem manager circuit 412 and the subsystem manager circuit 412 can resume normal operations. In an example, at operation 524, the bootloader starts and loads a firmware image (e.g., a new or updated firmware image) to the subsystem manager circuit 412, and then loads a firmware image (e.g., a new or updated firmware image) to the host interface circuit 410. While the host interface circuit 410 firmware image is loaded to its IMEM, the host interface circuit 410 is suspended or in a paused state. If any Host event happens during this time of firmware image loading, a timeout error can occur. To help avoid this, host interface events can be unmasked in the subsystem manager circuit 412 so that the subsystem manager circuit 412 can handle such host events and avoid a timeout.

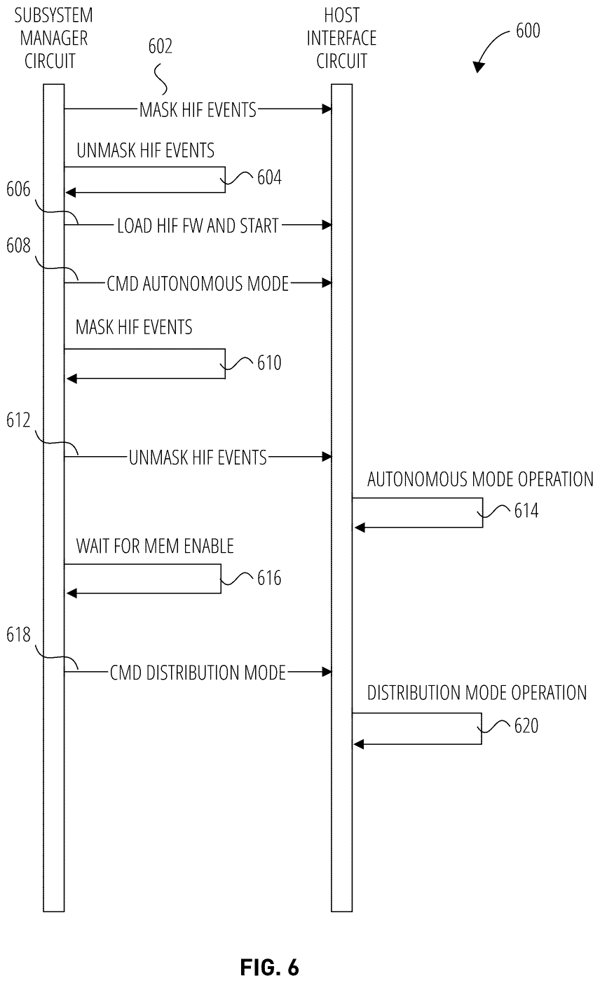

FIG. 6 illustrates generally an example of a second timing diagram 600 for interface management during an internal reset, such as for the example CXL device 402. In an example, the second timing diagram 600 is a continuation of the first timing diagram 500 and begins with operation 602 following operation 524. In an example, the second timing diagram 600 illustrates generally a process that can include updating firmware of the host interface circuit 410, and returning operation of the example CXL device 402 to distribution mode.

In the example of the second timing diagram 600, operation 602 can include or use the subsystem manager circuit 412 to mask host interface events. At operation 604, the second timing diagram 600 can unmask host interface events. In an example, operation 602 includes masking host events on the host interface circuit 410 and, at operation 604, unmasking host events on the subsystem manager circuit 412. In this example, the bootloader handles the host events in the subsystem manager circuit 412.

At operation 606, new firmware can be loaded to the host interface circuit 410. In an example, the subsystem manager circuit 412 can manage the loading and implementation of the new firmware for the host interface circuit 410. Operation 606 can include loading (e.g., using a bootloader) the new firmware and initializing the host interface circuit 410. At operation 608, the subsystem manager circuit 412 can command the host interface circuit 410 to operate in the autonomous mode until further instructions are sent to the host interface circuit 410 by the subsystem manager circuit 412.

At operation 610, the subsystem manager circuit 412 can mask host interface events for the example CXL device 402 and, at operation 612, the subsystem manager circuit 412 can unmask the host interface events. While the interface events are masked or handled by the subsystem manager circuit 412, the host interface circuit 410 can remain operational in autonomous mode (operation 614).

At operation 616, the second timing diagram 600 can include waiting for a host command, such as a memory enable command from the host device. Upon receipt of such a command, the subsystem manager circuit 412 can initiate the distribution mode for the example CXL device 402. At operation 620, the host interface circuit 410 and the subsystem manager circuit 412 can operate in the distribution mode.

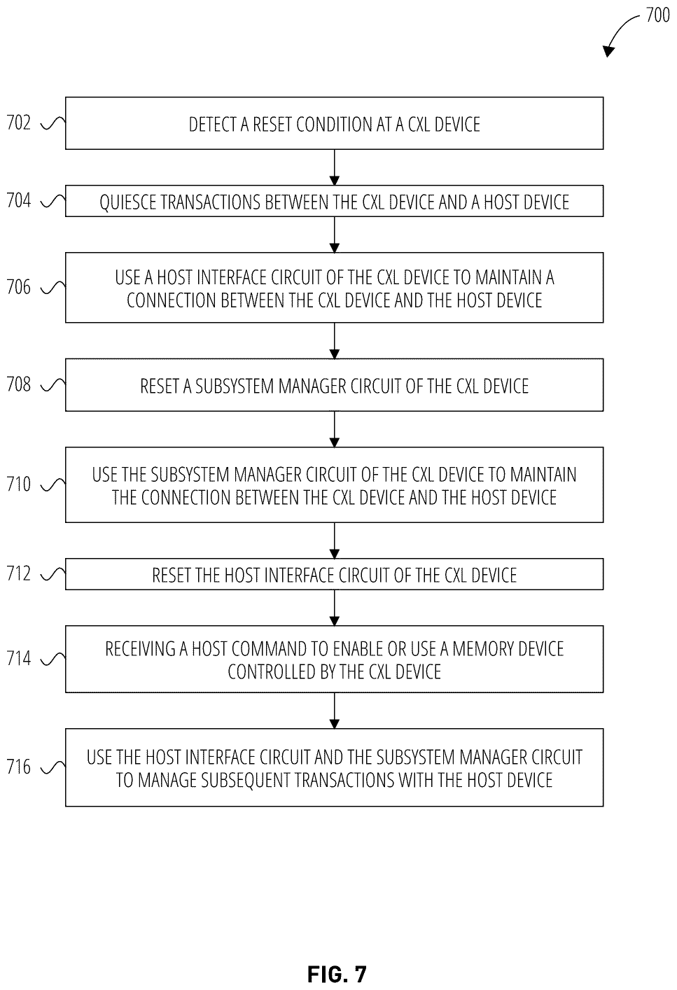

FIG. 7 illustrates an example of a first method 700 for resetting at least a portion of a CXL device. The first method 700 depicts a particular sequence of operations that may be altered without departing from the scope of the present disclosure. For example, some of the operations depicted may be performed in parallel or in a different sequence. In other examples, different components of an example device or system that implements the first method 700 may perform functions at substantially the same time or in a specific sequence.

In an example, the first method 700 includes detecting a reset condition at a CXL device at operation 702. For example, operation 702 can include detecting a reset condition or receiving a reset trigger at the example CXL device 402. The reset condition or trigger can include or can indicate a firmware update, a detected device fault or failure, or other condition.

In an example, the reset condition or trigger can include a host-initiated reset command. In an example that includes the example CXL device 402 operable in multiple modes, including autonomous mode and distribution mode, operation 702 can include initiating the autonomous mode.

At operation 704, the first method 700 can include quiescing transactions between the CXL device and a host device. In an example, operation 704 includes reducing to zero a number of CXL transaction credits issued by the example CXL device 402 to the host device.

At operation 706, the first method 700 can include using the host interface circuit 410 of the example CXL device 402 to maintain a connection between the example CXL device 402 and the host device. Maintaining the connection at operation 706 can include acknowledging main-band or side-band requests or commands from the host device.

At operation 708, the first method 700 can include resetting the subsystem manager circuit 412 of the example CXL device 402. Resetting the subsystem manager circuit 412 can include, for example, loading new or updated ROM code, or changing other configuration registers or commands for the example CXL device 402, and can further include rebooting and initializing the subsystem manager circuit 412.

At operation 710, the first method 700 can include using the subsystem manager circuit 412 of the example CXL device 402 to maintain the connection between the example CXL device 402 and the host device. Maintaining the connection at operation 710 can include acknowledging main-band or side-band requests or commands from the host device.

At operation 712, the first method 700 can include resetting the host interface circuit 410 of the example CXL device 402. Resetting the host interface circuit 410 can include, for example, loading new or updated ROM code, or changing other configuration registers or commands for the example CXL device 402, and can further include rebooting and initializing the host interface circuit 410.

Following operation 712, any new or updated firmware for the example CXL device 402 can be installed and all portions of the example CXL device 402 can be ready for use. However, in some examples, the host interface circuit 410 can remain uninitialized or otherwise partially or fully powered down until full operation of the host interface circuit 410, the subsystem manager circuit 412, or the example CXL device 402 is requested by the host device. For example, at operation 714, the first method 700 can include receiving a command from the host device to enable or use a memory device that is coupled to, or controlled by, the example CXL device 402. For example, the memory device can be controlled by the subsystem manager circuit 412 of the example CXL device 402. In response to receiving the host command, the host interface circuit 410 can be initialized and booted. The host interface circuit 410 can then resume managing host commands, host resets, and/or side-band communications while the subsystem manager circuit 412 can be used to initialize the memory device and carry out other operations or functions of the example CXL device 402. Accordingly, operation 716 can include or use the host interface circuit 410 and the subsystem manager circuit 412 to manage subsequent transactions with the host device.

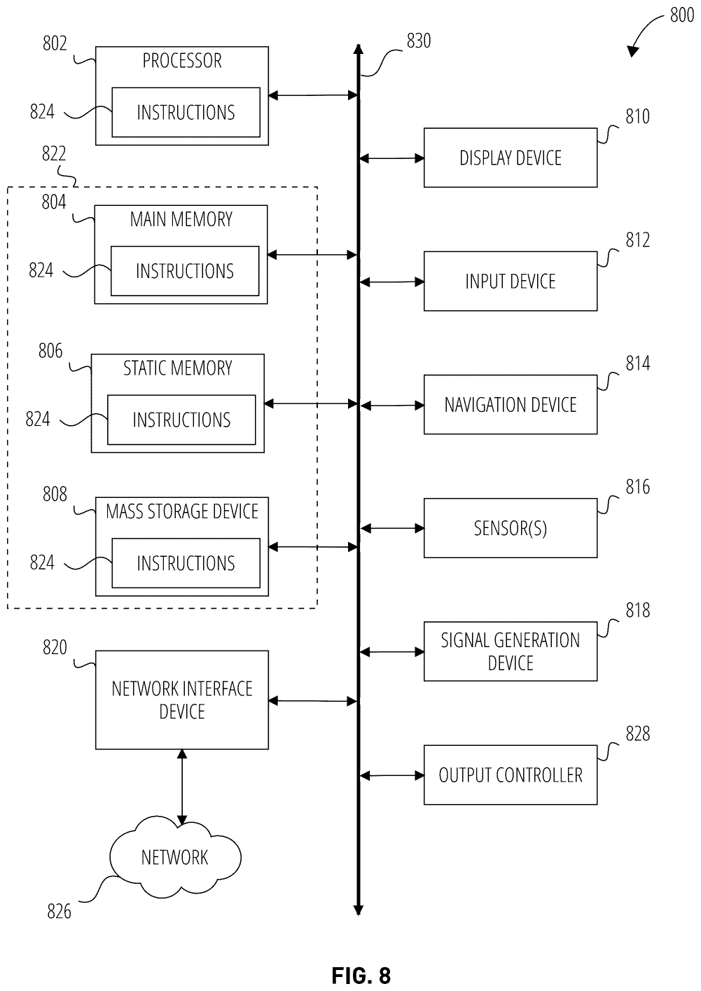

FIG. 8 illustrates a block diagram of an example machine 800 with which, in which, or by which any one or more of the techniques (e.g., methodologies) discussed herein can be implemented. Examples, as described herein, can include, or can operate by, logic or a number of components, or mechanisms in the machine 800. Circuitry (e.g., processing circuitry) is a collection of circuits implemented in tangible entities of the machine 800 that include hardware (e.g., simple circuits, gates, logic, etc.). Circuitry membership (e.g., as belonging to a host-side device or process, or to an accelerator-side device or process) can be flexible over time. Circuitries include members that can, alone or in combination, perform specified operations when operating. In an example, hardware of the circuitry can be immutably designed to carry out a specific operation (e.g., hardwired) for example using the device logic and memory controller 224, or the host interface circuit 410, or the subsystem manager circuit 412, or using a specific command execution unit thereof. In an example, the hardware of the circuitry can include variably connected physical components (e.g., command execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating.

In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. In alternative embodiments, the machine 800 can operate as a standalone device or can be connected (e.g., networked) to other machines. In a networked deployment, the machine 800 can operate in the capacity of a server machine, a client machine, or both in server-client network environments. In an example, the machine 800 can act as a peer machine in peer-to-peer (P2P) (or other distributed) network environment. The machine 800 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Any one or more of the components of the machine 800 can include or use one or more instances of the host device 202 or the CXL device 204 or the example CXL device 402 or other component in or appurtenant to the computing system 100. The machine 800 (e.g., computer system) can include a hardware processor 802 (e.g., the host processor 216, the device logic and memory controller 224, a central processing unit (CPU), a graphics processing unit (GPU), a hardware processor core, or any combination thereof), a main memory 804, a static memory 806 (e.g., memory or storage for firmware, microcode, a basic-input-output (BIOS), unified extensible firmware interface (UEFI), etc.), and mass storage device 808 or memory die stack, hard drives, tape drives, flash storage, or other block devices) some or all of which can communicate with each other via an interlink 830 (e.g., bus). The machine 800 can further include a display device 810, an alphanumeric input device 812 (e.g., a keyboard), and a user interface (UI) Navigation device 814 (e.g., a mouse). In an example, the display device 810, the input device 812, and the UI navigation device 814 can be a touch screen display. The machine 800 can additionally include a mass storage device 808 (e.g., a drive unit), a signal generation device 818 (e.g., a speaker), a network interface device 820, and one or more sensor(s) 816, such as a global positioning system (GPS) sensor, compass, accelerometer, or other sensor. The machine 800 can include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 802, the main memory 804, the static memory 806, or the mass storage device 808 can be, or include, a machine-readable media 822 on which is stored one or more sets of data structures or instructions 824 (e.g., software) embodying or used by any one or more of the techniques or functions described herein. The instructions 824 can also reside, completely or at least partially, within any of registers of the hardware processor 802, the main memory 804, the static memory 806, or the mass storage device 808 during execution thereof by the machine 800. In an example, one or any combination of the hardware processor 802, the main memory 804, the static memory 806, or the mass storage device 808 can constitute the machine-readable media 822. While the machine-readable media 822 is illustrated as a single medium, the term “machine-readable medium” can include a single medium or multiple media (e.g., a centralized or distributed database, or associated caches and servers) configured to store the one or more instructions 824.

The term “machine-readable medium” can include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable media 822 can be representative of the instructions 824, such as instructions 824 themselves or a format from which the instructions 824 can be derived. This format from which the instructions 824 can be derived can include source code, encoded instructions (e.g., in compressed or encrypted form), packaged instructions (e.g., split into multiple packages), or the like. The information representative of the instructions 824 in the machine-readable media 822 can be processed by processing circuitry into the instructions to implement any of the operations discussed herein. For example, deriving the instructions 824 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 824.

In an example, the derivation of the instructions 824 can include assembly, compilation, or interpretation of the information (e.g., by the processing circuitry) to create the instructions 824 from some intermediate or preprocessed format provided by the machine-readable media 822. The information, when provided in multiple parts, can be combined, unpacked, and modified to create the instructions 824. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 824 can be further transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 can include one or more physical jacks (e.g., Ethernet, coaxial, or phone jacks) or one or more antennas to connect to the network 826. In an example, the network interface device 820 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software. A transmission medium is a machine readable medium.

To better illustrate the methods and apparatuses described herein, such as can be used to facilitate CXL device reset while maintaining a host connection, a non-limiting set of Example embodiments are set forth below as numerically identified Examples.

Example 1 is a memory device comprising: a host interface circuit configured to receive commands from a host device via a compute express link (CXL) interconnect; and a subsystem manager circuit configured to control transactions with a memory device; wherein the host interface circuit is configured to suppress communication with the host device and maintain a connection with the host device while the subsystem manager circuit undergoes a reset that is initiated internally to the memory device.

In Example 2, the subject matter of Example 1 optionally includes the reset in response to a detected device fault of the memory device.

In Example 3, the subject matter of Examples 1-2 optionally includes wherein the reset in response to a firmware update for the memory device.

In Example 4, the subject matter of Examples 1-3 optionally includes, in an autonomous operating mode, the host interface circuit is configured to manage CXL and side-band commands, PCIe resets, and/or CXL resets, received from the host device, and in a distribution operating mode, the subsystem manager circuit is configured to manage CXL and side-band commands received from the host device. In an example, in the distribution mode, PCIe PHY Reset, PHY programming and Link up CXL.io reset can be handled by the host interface circuit, while IO path reset and device back-end reset can be handled by the subsystem manager circuit.

In Example 5, the subject matter of Example 4 optionally includes, in the autonomous operating mode and in the distribution operating mode, the host interface circuit is configured to coordinate a device response to any one or more of a PCIe reset, a CXL reset (e.g., as notified using CXL.io to write to a memory mapped register of the CXL device), a transaction layer packet, and a side-band request received from the host device.

In Example 6, the subject matter of Examples 4-5 optionally includes a cache memory, wherein in the autonomous operating mode, the subsystem manager circuit is configured to load contents of the cache memory to the memory device before initiating the reset.

In Example 7, the subject matter of Examples 4-6 optionally includes the memory device, wherein the memory device is a DRAM memory device.

In Example 8, the subject matter of Examples 4-7 optionally includes the subsystem manager circuit configured to determine if the memory device is initialized prior to using the autonomous operating mode.

In Example 9, the subject matter of Examples 4-8 optionally includes a logic circuit configured to initiate the autonomous operating mode (1) following a cold boot and before the memory device is enabled by the host device, and/or (2) in response to a reset command received from the host device, and/or (3) in response to a reset initiated by the memory device.

In Example 10, the subject matter of Examples 4-9 optionally includes, in the autonomous operating mode, the host interface circuit is configured to suppress communication with the host device by representing zero CXL transaction credits are available to the host device.

Example 11 is a method comprising: detecting a memory device reset condition at a memory device, wherein the memory device is coupled to a host device using a compute express link (CXL) interconnect; in response to the reset condition: during a first phase, quiescing transactions with the host device, using a host interface circuit of the memory device to maintain a connection with the host device, and resetting a subsystem manager circuit of the memory device; during a second phase that follows the first phase, using the subsystem manager circuit of the memory device to maintain the connection with the host device while resetting the host interface circuit of the memory device; and during a third phase that follows the second phase, using the host interface circuit of the memory device and the subsystem manager circuit of the memory device to manage transactions with the host device.

In Example 12, the subject matter of Example 11 optionally includes detecting the memory device reset condition including detecting a fault condition internally to the memory device.

In Example 13, the subject matter of Examples 11-12 optionally includes detecting the memory device reset condition including receiving an indication that a firmware update is available for the memory device.

In Example 14, the subject matter of Example 13 optionally includes quiescing transactions with the host device including allowing memory device-internal commands to complete before resetting the subsystem manager circuit of the memory device.

In Example 15, the subject matter of Examples 11-14 optionally includes detecting the memory device reset condition including receiving a reset command from the host device to reset at least a portion of the memory device.

In Example 16, the subject matter of Examples 11-15 optionally includes the third phase initiated in response to receiving a command from the host device to enable or use the memory device.

In Example 17, the subject matter of Examples 11-16 optionally includes the first phase concluding when a reset of the subsystem manager circuit is completed.

Example 18 is a method for operating an peripheral device (e.g., comprising a memory device, an accelerator device, or other device), the peripheral device coupled to a host device using a compute express link (CXL) interconnect, the method comprising: operating a host interface circuit of the peripheral device in one of an autonomous mode and a distribution mode, wherein in the autonomous mode the host interface circuit is configured to maintain a connection and suppress communication between the host device and the peripheral device while a subsystem manager circuit of the peripheral device is unavailable, and wherein in the distribution mode, the host interface circuit is configured to allow communication between the host device and the subsystem manager circuit of the peripheral device.

In Example 19, the subject matter of Example 18 optionally includes the autonomous mode is initiated in response to a reset command received by the peripheral device; and wherein in the autonomous mode and in response to the reset command, the subsystem manager circuit is configured to perform a reset routine that includes loading new firmware for the subsystem manager circuit.

In Example 20, the subject matter of Examples 18-19 optionally includes the autonomous mode is initiated in response to a fault condition detected at the peripheral device; and wherein in the autonomous mode, the subsystem manager circuit is configured to perform a reset routine that includes: in response to the detected fault condition, resetting the subsystem manager circuit while the host interface circuit maintains the connection between the host device and the peripheral device; and resetting the host interface circuit while the subsystem manager circuit maintains the connection between the host device and the peripheral device.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-10.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A memory device comprising:
a host interface circuit configured to receive commands from a host device via a compute express link (CXL) interconnect; and
processing logic circuitry configured to control transactions with a memory device;
wherein the host interface circuit is configured to suppress communication with the host device and maintain a connection with the host device while the processing logic circuitry undergoes a reset that is initiated internally to the memory device.

2. The memory device of claim 1, wherein the reset is in response to a detected device fault of the memory device.

3. The memory device of claim 1, wherein the reset is in response to a firmware update for the memory device.

4. The memory device of claim 1, wherein in an autonomous operating mode, the host interface circuit is configured to manage CXL and side-band commands received from the host device; and
wherein in a distribution operating mode, the processing logic circuitry is configured to manage CXL and side-band commands received from the host device.

5. The memory device of claim 4, wherein in the autonomous operating mode and in the distribution operating mode, the host interface circuit is configured to coordinate a device response to any one or more of a PCIe reset, a CXL reset, a transaction layer packet, and a side-band request received from the host device.

6. The memory device of claim 4, further comprising a cache memory;
wherein in the autonomous operating mode, the processing logic circuitry is configured to load contents of the cache memory to the memory device before initiating the reset.

7. The memory device of claim 4, further comprising the memory device, wherein the memory device is a DRAM memory device.

8. The memory device of claim 4, wherein the processing logic circuitry is configured to determine the memory device is initialized prior to using the autonomous operating mode.

9. The memory device of claim 4, comprising a logic circuit configured to initiate the autonomous operating mode
(1) following a cold boot and before the memory device is enabled by the host device, or
(2) in response to a reset command received from the host device, or
(3) in response to a reset initiated by the memory device.

10. The memory device of claim 4, wherein in the autonomous operating mode, the host interface circuit is configured to suppress communication with the host device by representing zero CXL transaction credits are available to the host device.

11. A method comprising:
detecting a reset condition at a memory device, wherein the memory device is coupled to a host device using a compute express link (CXL) interconnect;
in response to the reset condition:
during a first phase, quiescing transactions with the host device, using a host interface circuit of the memory device to maintain a connection with the host device, and resetting processing logic circuitry of the memory device;
during a second phase that follows the first phase, using the processing logic circuitry of the memory device to maintain the connection with the host device while resetting the host interface circuit of the memory device; and
during a third phase that follows the second phase, using the host interface circuit of the memory device and the processing logic circuitry of the memory device to manage transactions with the host device.

12. The method of claim 11, wherein detecting the memory device reset condition includes detecting a fault condition internally to the memory device.

13. The method of claim 11, wherein detecting the memory device reset condition includes receiving an indication that a firmware update is available for the memory device.

14. The method of claim 13, wherein quiescing transactions with the host device includes allowing memory device-internal commands to complete before resetting the processing logic circuitry, wherein the processing logic circuitry comprises a subsystem manager circuit of the memory device.

15. The method of claim 11, wherein detecting the memory device reset condition includes receiving a reset command from the host device to reset at least a portion of the memory device.

16. The method of claim 11, wherein the third phase is initiated in response to receiving a command from the host device to enable the memory device.

17. The method of claim 11, wherein the first phase concludes when a reset of the processing logic circuitry is completed.

18. A method for operating a peripheral device coupled to a host device using a compute express link (CXL) interconnect, the method comprising:
operating a host interface circuit of the peripheral device in one of an autonomous mode and a distribution mode,
wherein in the autonomous mode the host interface circuit is configured to maintain a connection and suppress communication between the host device and the peripheral device while processing logic circuitry of the peripheral device is unavailable, and
wherein in the distribution mode, the host interface circuit is configured to allow communication between the host device and the processing logic circuitry of the peripheral device.

19. The method of claim 18, wherein the autonomous mode is initiated in response to a reset command received by the peripheral device; and
wherein in the autonomous mode and in response to the reset command, the processing logic circuitry is configured to perform a reset routine that includes loading new firmware for the processing logic circuitry, and wherein the processing logic circuitry comprises a subsystem manager circuit.

20. The method of claim 18, wherein the autonomous mode is initiated in response to a fault condition detected at the peripheral device; and
wherein in the autonomous mode, the processing logic circuitry is configured to perform a reset routine that includes:
in response to the detected fault condition, resetting a subsystem manager circuit while the host interface circuit maintains the connection between the host device and the peripheral device; and
resetting the host interface circuit while the subsystem manager circuit maintains the connection between the host device and the peripheral device.
